(19) United States
(12) Patent Application Publication
(10) Pub. No.: US 2013/0087269 A1
(43) Pub. Date: Apr. 11, 2013

(54) RADIATION CURED REINFORCEMENT STACKS

(71) Applicant: Ming Kwan Tse, Katy, TX (US)

(72) Inventor: Ming Kwan Tse, Katy, TX (US)

(21) Appl. No.: 13/641,281

(22) PCT Filed: Mar. 3, 2011
(86) PCT No.: PCT/US11/27010

§ 371 Date: Dec. 20, 2012

Related U.S. Application Data
(60) Provisional application No. 61/324,223, filed on Apr. 14, 2010.

(51) Int. Cl. B32B 37/12

(52) U.S. Cl. CPC B32B 37/12
USPC 156/184; 156/380.9

(57) ABSTRACT

In one aspect, the present disclosure relates to a method to bond fiber reinforced polymer composite tape layers to make reinforcement stacks. The method includes collecting a plurality of composite tape layers to form a reinforcement stack, helically winding the reinforcement stack; and curing an adhesive on one or more surfaces of the plurality of composite tape layers by exposing the reinforcement stack to radiation. In another aspect, the present disclosure relates to a method to bond fiber reinforced polymer composite reinforcement stacks. The method includes collecting a plurality of composite tape layers each comprising at least one resin-rich surface to form a reinforcement stack, helically winding the reinforcement stack, and bonding the reinforcement stack by exposing the reinforcement stack to radiation. In another aspect, the present disclosure relates to an apparatus to bond polymer composite reinforcement stacks.

### BACKGROUND OF THE DISCLOSURE

1. Field of the Disclosure

The present invention relates to fiber reinforced polymer composite reinforcement stacks. Specifically, this invention relates to bonding or curing reinforcement stacks by use of electron beam or radiation.

2. Description of the Related Art

Flexible fiber-reinforced pipe is manufactured to provide a flexible pipe to be used in natural resource deposit extraction. Flexible fiber-reinforced pipes may be made with reinforcement stacks composed of fiber-reinforced polymer composite tape. Inter-laminar adhesive may be applied to surfaces of the tapes to allow for bonding between the tapes to form the reinforcement stack. After application of the adhesive, the pipe may be thermally cured, thereby allowing the inter-laminar adhesive to bond and strengthen the reinforcement stack.

To thermally cure the inter-laminar adhesive, the entire pipe assembly must be conveyed through an oven or other large thermal applicator, so that the adhesive may be heated to a proper curing temperature, and so that the curing may be consistent and even throughout.

### SUMMARY OF THE CLAIMED SUBJECT MATTER

In one aspect, the present disclosure relates to a method to bond fiber reinforced polymer composite tapes to make reinforcement stacks. The method includes collecting a plurality of composite tapes to form a reinforcement stack, helically winding the reinforcement stack, and curing an adhesive on one or more surfaces of the plurality of composite tapes by exposing the reinforcement stack to radiation.

In another aspect, the present disclosure relates to a method to bond fiber reinforced polymer composite reinforcement stacks. The method includes collecting a plurality of composite tapes each comprising at least one resin-rich surface to form a reinforcement stack, helically winding the reinforcement stack, and bonding the reinforcement stack by exposing the reinforcement stack to radiation.

In another aspect, the present disclosure relates to an apparatus to fiber reinforce a composite pipe. The apparatus includes a plurality of tape dispensers configured to dispense a plurality of fiber reinforced polymer composite tape layers, a collector to form the plurality of composite tape layers into a at least one reinforcement stack, and a radiation source configured to cure the at least one reinforcement stack, in which an adhesive is on one or more surfaces of the composite tape layers.

### BRIEF DESCRIPTION OF DRAWINGS

Features of the present disclosure will become more apparent from the following description in conjunction with the accompanying drawings.

FIG. 1 is a flow chart of a process to cure tape stacks in accordance with one or more embodiments of the present disclosure.

FIG. 2A is a side view schematic of a pipe assembly line in accordance with one or more embodiments of the present disclosure. FIG. 2B is an end on view schematic of the pipe assembly line of FIG. 2A.

FIG. 3A is a perspective view of tape layers in accordance with one or more embodiments of the present disclosure. FIG. 3B is a perspective view of a reinforcement stack in accordance with one or more embodiments of the present disclosure.

FIGS. 4A-4D are side view schematics of stack assemblies in accordance with one or more embodiments of the present disclosure.

### DETAILED DESCRIPTION

To form certain structural layers of a flexible fiber-reinforced pipe, “reinforcement stacks” may be helically wound to provide reinforcement, support, structure, strength, and/or protection. Formation and application of the reinforcement stacks to form a pipe may be costly and time intensive, as the reinforcement stacks may be formed from layers of fiber reinforced polymer composite tape that may be gathered to form the reinforcement stacks. The reinforcement stacks may be formed from bonded tape layers, and the bonding may require curing to bond the tape layers to achieve appropriate operational properties. For example, the reinforcement stacks may (desirably) be chemically resistant, thermally insulated, strong enough to provide support, flexible enough to provide relative movement and/or sliding, flexible enough to allow the pipe to bend, and/or configured to any other necessary and/or required operational properties.

The tape layers that may form the reinforcement stacks may be fiber reinforced layers. Specifically, the tapes may comprise composite matrix materials and/or polymers, including, but not limited to polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, epoxy resin, polyurethane, and/or polyoxymethylene and/or combinations thereof. The composite matrix materials and/or polymers that compose the tape layers may be partially or fully cured. Further, the tape layers may be reinforced with fibers that may be unidirectional. Additionally, the fibers may be made of materials such as aramids, aromatics, ceramics, polyolefin, carbon fiber, graphite fiber, fiberglass, E-glass, chemical resistant E-glass, S-glass, metallic fibers, and/or any other fibrous material and/or any combinations thereof.

The composite tape layers may be gathered to form the reinforcement stacks at the same time as installation of the reinforcement stacks onto the surface of the pipe. Accordingly, application of a bonding material, such as an inter-laminar adhesive, may be applied during the reinforcement stack forming and installation processes. Alternatively, the inter-laminar adhesive may be applied to the surfaces of the tape layers prior to the reinforcement stack forming and installation process, such as during the tape manufacturing process, or an intermediate process between tape manufacture and reinforcement stack forming. Alternatively, the reinforcement stacks may be formed by an independent manufacturing process prior to the manufacturing process of the flexible pipe. Further, the reinforcement stacks may be helically wound without application to a pipe. Additionally, at the time of application to the pipe, the reinforcement stacks may be partially cured. Alternatively, the tape layers that may form the reinforcement stacks may be partially cured or fully cured at the time of applying the reinforcement stacks to the pipe.

According to one or more embodiments of the present disclosure, the reinforcement stacks may be formed by placing films of adhesive (similar to a tape) between each layer of tape that may be collected (or stacked) to form the reinforcement stack. Alternatively, a film of adhesive may be calendared onto one or more surfaces of the tape layers, for example by rolling application and/or running the film and tape layers between rollers to compress the adhesive onto the surface of the tape layer. Alternatively still, a liquid adhesive may be sprayed and/or dispensed to form a layer of adhesive on one or more surfaces of the tape layers. Moreover, a powder adhesive may be applied to one or more surfaces of the tape layers, for example, by electrostatic application. Further, those skilled in the art will appreciate that other methods and/or processes or combinations thereof of application of the adhesive to one or more surfaces of the tape layers may be used without deviating from the scope of the present disclosure.

Further, the adhesive employed may be designed to cure fully (i.e., to bond) upon exposure to radiation. As defined herein radiation may be any form of radiation, high-energy radiation, and/or particle radiation known in the art, including, but not limited to UV radiation, electron beam, pulsed infrared radiation, and laser radiation.

After application of the adhesive, the tape layers may be collected to form the reinforcement stacks. The reinforcement stacks may then be helically wound for example, onto the surface of a pipe during manufacture and/or assembly of the pipe. The helically wound reinforcement stacks may then be exposed to radiation, such as electron beam radiation, laser radiation, pulsed infrared radiation, UV radiation, and/or thermal radiation that may be configured to cure the adhesive and bond the tape layers to form bonded reinforcement stacks.

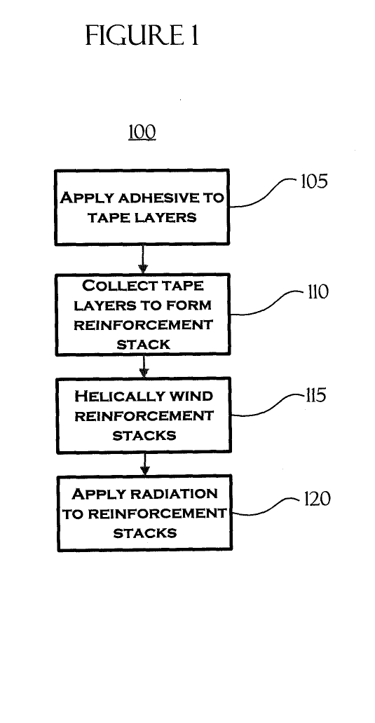

Referring to FIG. 1, a process of curing composite reinforcement stacks 100 is shown. First, at step 105, an adhesive may be applied to one or more surfaces of tape layers that may be collected to form a reinforcement stack. The surfaces may be contact surfaces between adjacently collected tape layers. For example, the contact surfaces may be top and bottom surfaces of the tape layers. Further, the top most tape layer of a reinforcement stack may not have adhesive applied to the top surface thereof, and the bottom most tape layer of a reinforcement stack may not have adhesive applied to the bottom surface thereof. Accordingly, when the reinforcement stack may be installed on a pipe section, the reinforcement stack may not bond with adjacent reinforcement stacks, surfaces below the reinforcement stack to which the reinforcement stack may be applied, or to surfaces and/or layers which may be applied over the reinforcement stack.

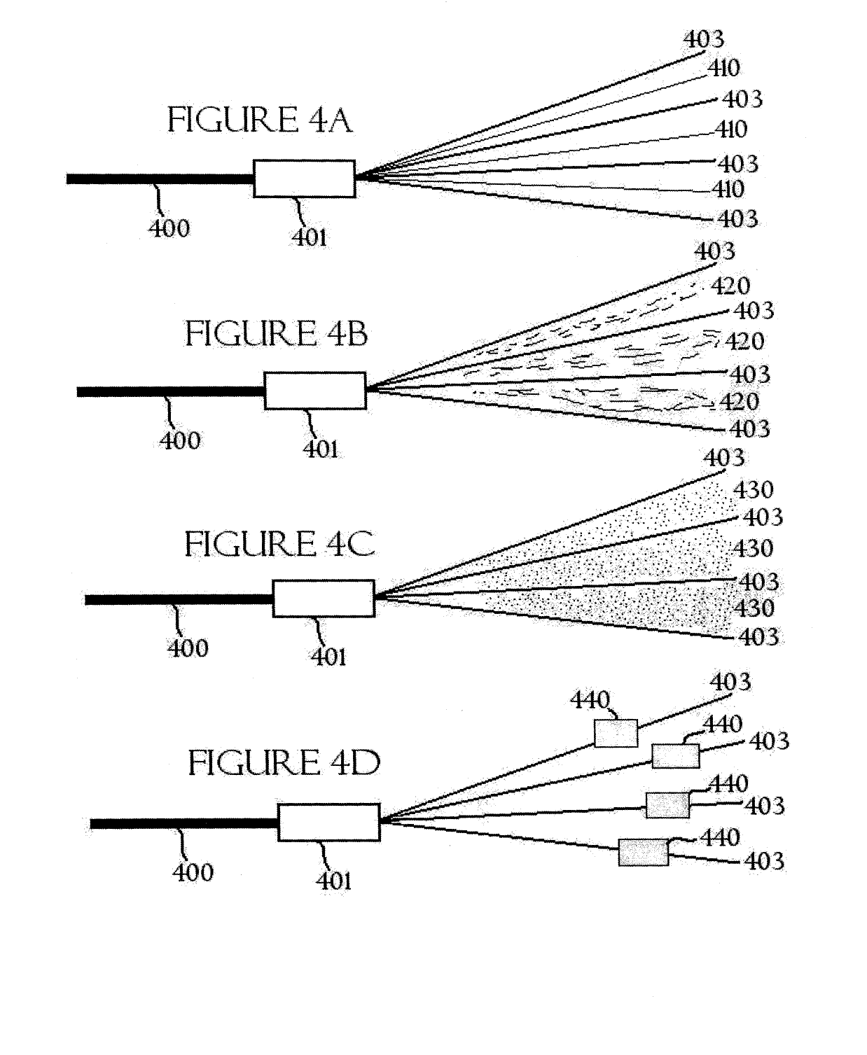

Application of the adhesive may be made, for example, in any of the ways shown in FIGS. 4A through 4D (described below), or the adhesive may be applied to one or more surfaces of the tape layers by any means known in the art. For example, an adhesive film, manufactured in advance, may be placed between adjacent tape layers. Alternatively, a liquid or fluid may be sprayed onto one or more surfaces of the tape layers. Or, a powder may be applied to one or more surfaces by use of electrostatic application or other powder application means. Or, rollers or other means may be used to calendar a film onto one or more surfaces of the tape layer. Further, those skilled in the art will appreciate that other application means may be used without deviating from the scope of the present disclosure, including, but not limited to spraying, fluid-jet through nozzle application, roller coating, dipping, or manual application.

As noted, the adhesive may be one that may be cured by UV radiation, electron beam radiation, pulsed infrared beam radiation, laser radiation, and/or other high-energy radiation and/or particle radiation. For example, the adhesive may include polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, epoxy resin, polyurethane, and/or polyoxymethylene and/or other adhesives known in the art and/or combinations thereof. Further, for example, an adhesive may be provided in a film, fluid, solid, gel, and/or powder state, thereby allowing for any particular type of application that may be necessary and/or available during manufacturing of the reinforcement stacks. Accordingly, the adhesive may be partially cured or completely uncured at the time of application to the tape layers.

In an alternative embodiment in accordance with one or more embodiments of the present disclosure, an adhesive may be manufactured directly with or into the tape layers. For example, each tape layer may have a structural layer including fiber reinforcement, and may also have an adhesive layer, on one or more surfaces of the tape layer. Alternatively, the tape layer may be manufactured with an adhesive characteristic structurally incorporated into the tape layer. For example, a tape layer may have a resin rich surface, which may, when exposed to radiation as disclosed herein, bond with adjacent tape layers. Further, for example, the resin rich surface may be a partially cured resin, such that the tape layers may not require low temperature storage, may have long open time and long work time, and may not be sticky during manufacturing of the reinforcement stacks, but may bond when exposed to radiation as disclosed herein.

Although described herein as part of the process, the application of the adhesive may be performed prior to the manufacturing of reinforcement stacks, and, therefore, the process may begin at step 110.

At step 110 the tape layers may then be collected to form reinforcement stacks. The reinforcement stacks at this point are non-bonded so that the tape layers may move or slide relative to each other during the manufacturing process. The unbonded reinforcement stack may be pressed with sufficient pressure to allow for easy application when winding the reinforcement stack on the surface of a pipe structure, or when forming helical winds, however, the pressure may not be great enough to cause the adhesive to ooze and/or displace from between the tape layers.

The unbonded reinforcement stacks may then be helically wound and/or wound onto a pipe section at step 115. For example, the reinforcement stacks may be helically wound onto a pipe to provide strength and/or support. Further, the lay angle of application relative to the axis of the pipe of the helically wound reinforcement stack may be varied without departing from the scope of the present disclosure. For example, lower lay angles may provide more tensile strength and higher lay angles may provide more hoop strength and/or collapse resistance.

Finally, after the reinforcement stacks may be helically wound and/or applied to a pipe, the helically wound reinforcement stacks may be conveyed through a radiation applicator. For example, the radiation applicator may apply UV radiation, electron beam radiation, pulsed infrared beam radiation, laser radiation, and/or other high-energy radiation and/or particle radiation to the helically wound reinforcement stack. The radiation may be scanned over the surface of the helically wound reinforcement stacks as the helically wound reinforcement stacks may pass through the radiation applicator.

For example, during manufacture of a fiber-reinforced flexible pipe, a pipe may be conveyed down an assembly line, and layers and/or structural elements may be installed as the pipe may be conveyed. Further, as the pipe may be conveyed, the pipe may be rotated so that applicators, such as tape reels and/or other elements may remain stationary, while the pipe rotates and is conveyed along the line.

As the pipe may be conveyed down the assembly line, helical winds of reinforcement stacks may be applied. The helically wound reinforcement stacks may then pass through a radiation source so that radiation may be scanned over the surface of the helically wound reinforcement stacks. Full exposure of the reinforcement stacks to the radiation may be possible as the helically wound reinforcement stacks may be translated through the radiation source and the radiation source may be scanned at a high rate. Therefore, uniform bonding between each tape layer may be achieved, and bonded tape stacks may be formed. Preferably, the radiation intensity may be sufficient such that the inter-laminar adhesive adjacent to (and/or applied to) a tape layer closest to an inner diameter of the formed reinforcement stack may be sufficiently cured.

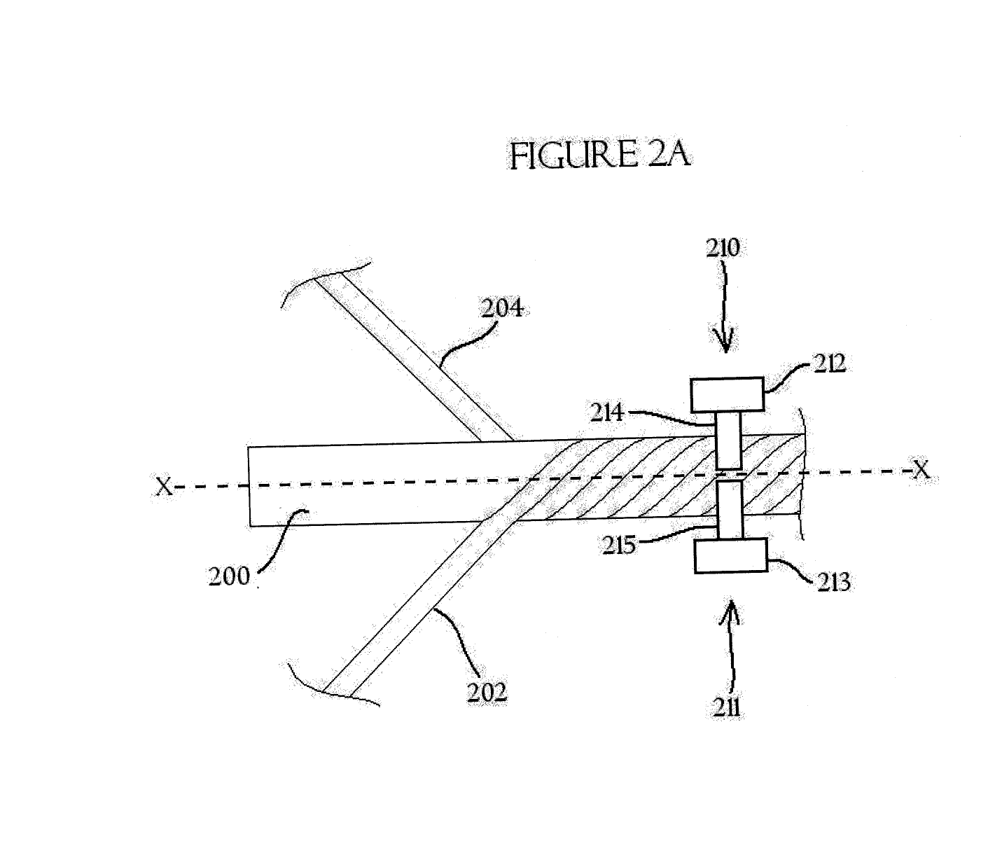

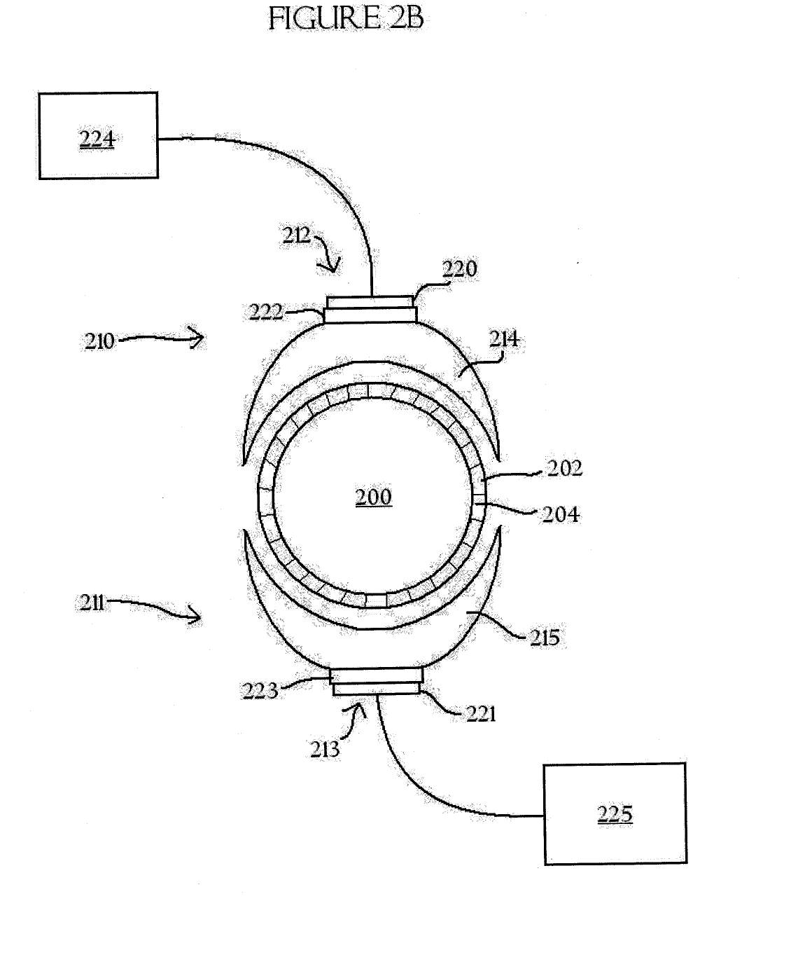

Now, referring to FIG. 2A, a side view of an assembly apparatus, in accordance with one or more embodiments of the present disclosure, is shown. A pipe section 200 may be conveyed along an axis X along a pipe assembly line. Further, pipe section 200 may be rotated about axis X, such that reinforcement stacks 202 and 204 may be helically wound onto the surface of pipe section 200. Tape stacks 202 and 204 may be pre-manufactured or may be manufactured just prior to application to pipe section 200, as described below. Further, although shown with a pipe section 200, reinforcement stacks 202 and 204 may be helically wound without pipe section 200.

Reinforcement stacks 202 and 204 may be fed from dispensers and/or winders (not shown). Alternatively, as discussed below, tape layers may be fed from dispensers and/or winders (not shown), and then fed through a collector to form reinforcement stacks 202 and 204. Examples of dispensers and/or winders may be found in U.S. Pat. No. 6,491,779, filed on Apr. 24, 2000, entitled “Method of Forming a Composite Tubular Assembly,” U.S. Pat. No. 6,804,942, filed on Sep. 27, 2002, entitled “Composite Tubular Assembly and Method of Forming Same,” U.S. Pat. No. 7,254,933, filed on May 6, 2005, entitled “Anti-collapse System and Method of Manufacture,” and U.S. Patent Application Publication 2009/0065630, filed on Sep. 11, 2007, entitled “Layered Tape Guide Spool and Alignment Device and Method,” all of which are hereby incorporated by reference in their entireties.

Further, although shown with only two reinforcement stacks 202 and 204 applied to pipe section 200, those skilled in the art will appreciate that more than two reinforcement stacks may be applied at a single time, without deviating from the scope of the present invention. Further, those skilled in the art will appreciate that a pipe section 200 may include, for example, a liner, anti-extrusion layers, pressure reinforcement layers, hoop strength reinforcement layers, membrane layers, tensile reinforcement layers, anti-wear layers, a jacket, and/or any other additional layers or combinations thereof without deviating from the scope of the present disclosure.

As pipe section 200 may be conveyed along the X axis during manufacturing, the pipe section 200, with applied reinforcement stacks 202 and 204 may be exposed to radiation from radiation sources 210 and 211 to cure elements of pipe section 200 and/or reinforcement stacks 202 and 204. For example, reinforcement stacks 202 and 204 may be partially cured reinforcement stacks of individual tape layers with inter-laminar adhesive applied between each of the layers that may form the reinforcement stack. Exposure to the radiation at radiation sources 210 and 211 may fully cure reinforcement stacks 202 and 204 to form bonded reinforcement stacks that may provide pressure reinforcement, hoop strength reinforcement, tensile reinforcement, and/or any other forms of reinforcement and/or protection to pipe section 200.

Radiation sources 210 and 211 may include energy sources, accelerators, generators, and/or other components in component boxes 212 and 213. Further, radiation sources 210 and 211 may include scanning horns 214 and 215 that may be configured to scan the radiation produced in component boxes 212 and 213 so that an even exposure of the radiation may be provided to the entire surface of pipe section 200. Radiation sources 210 and 211 may be located anywhere in the assembly process and/or apparatus, and, preferably, radiation sources 210 and 211 are located downstream in the process after the reinforcement stacks may be wound. The location of radiation sources 210 and 211 may be optimized to facilitate, for example, manufacturing, the curing and/or bonding process, quality, and/or productivity.

The radiation generated by radiation sources 210 and 211 may include UV radiation, electron beam radiation, pulsed infrared beam radiation, laser radiation, and/or other high-energy radiation and/or particle radiation.

For example, referring to FIG. 2B, electron beam radiation sources 210 and 211 may be provided to cure reinforcement stacks 202 and 204 that may be applied to an outer surface of a pipe section 200 during manufacturing. FIG. 2B shows an end-on view of the assembly process of FIG. 2A. Pipe section 200 may be helically wound with tape stacks 202 and 204, and as noted above, more than two tape stacks may be applied.

Radiation from radiation sources 210 and 211 may be distributed over the surface of pipe section 200 by use of horns 214 and 215. Although shown with only two radiation sources 210 and 211 and two corresponding horns 214 and 215, respectively, those skilled in the art will appreciate that more or less radiation sources and/or horns may be employed without deviating from the scope of the present disclosure.

Horns 214 and 215 may be scanning horns that may allow for a source and/or beam of radiation to be scanned across the surface of pipe section 200 so that reinforcement stacks 202 and 204 may be fully exposed to the radiation. For example, a magnet (not shown) of horns 214 and 215 may scan a radiation source at approximately 200 Hz. Accordingly, the surface of pipe section 200 may be fully and evenly exposed to radiation, thereby curing the inter-laminar adhesive located between the tape layers and bonding the tape layers to form bonded reinforcement stacks. Alternatively, the radiation may fully cure partially cured tape layers to bond the tape layers and form bonded reinforcement stacks.

As noted above, the radiation may include UV radiation, electron beam radiation, pulsed infrared beam radiation, laser radiation, and/or other high-energy radiation and/or particle radiation. As shown in FIG. 2B, horns 214 and 215 of radiation sources 210 and 211, respectively, may cover approximately 100% of the surface of pipe section 200, thereby allowing for complete radiation exposure to pipe section 200. Horns 214 and 215 may have component boxes 212 and 213 attached, respectively. Component boxes 212 and 213 may include, for example, electron beam sources 220 and 221, respectively, and accelerators 222 and 223, respectively. Electron beam sources 220 and 221 may generate electrons that may be accelerated in accelerators 222 and 223 and then scanned over the surface of pipe section 200 by horns 214 and 215. Electron beam sources 220 and 221 and accelerators 222 and 223 may include, for example, high voltage insulators, filaments, strong magnet fields, ultra-high vacuums, ultra-thin windows, and/or other elements and/or any additional parts necessary for generating an electron beam.

Alternatively, the electron beam sources 220 and 221 may be configured to provide other forms of radiation. For example, the radiation may be UV, infrared, laser, and/or other high-energy radiation and/or particle radiation. Power may be provided to component boxes 212 and 213 by generators 224 and 225, respectively. Alternatively, a single generator may provide power to all radiation sources employed or other configurations of generators may be used without deviating from the scope of the present disclosure.

As noted above, a scanning rate of 200 Hz with an electron beam, or other radiation, may be desired for complete exposure. Accordingly, a medium to high energy source (generator) may be used, for example a generator providing 2.5 to 10 MeV may be provided to generate an electron beam of about one inch in diameter. A direct power, for example, of 50 kW or more may be used with an accelerator tube to accelerate the electrons in the electron beam. The magnet of the scanning horn may then scan the electron beam at a rate of about 200 Hz. In this configuration and electron beam example, the radiation source may provide a curtain of electrons (radiation) of about four to six feet wide, thus exposing the entire surface of the reinforcement stacks. Accordingly, under these conditions, an assembled helically wound reinforcement stack may travel through an assembly line at high speeds. For example, because curing of the adhesive may take place in seconds, the process may allow for a manufacturing process up to 10 meters per minute or more.

As shown in FIG. 2A, the radiation sources 210 and 211 are located downstream from a point at which the reinforcement stacks 202 and 204 are helically wound. Accordingly, the structure of reinforcement stacks 202 and 204, as helically wound, may be structurally bonded by application of the radiation.

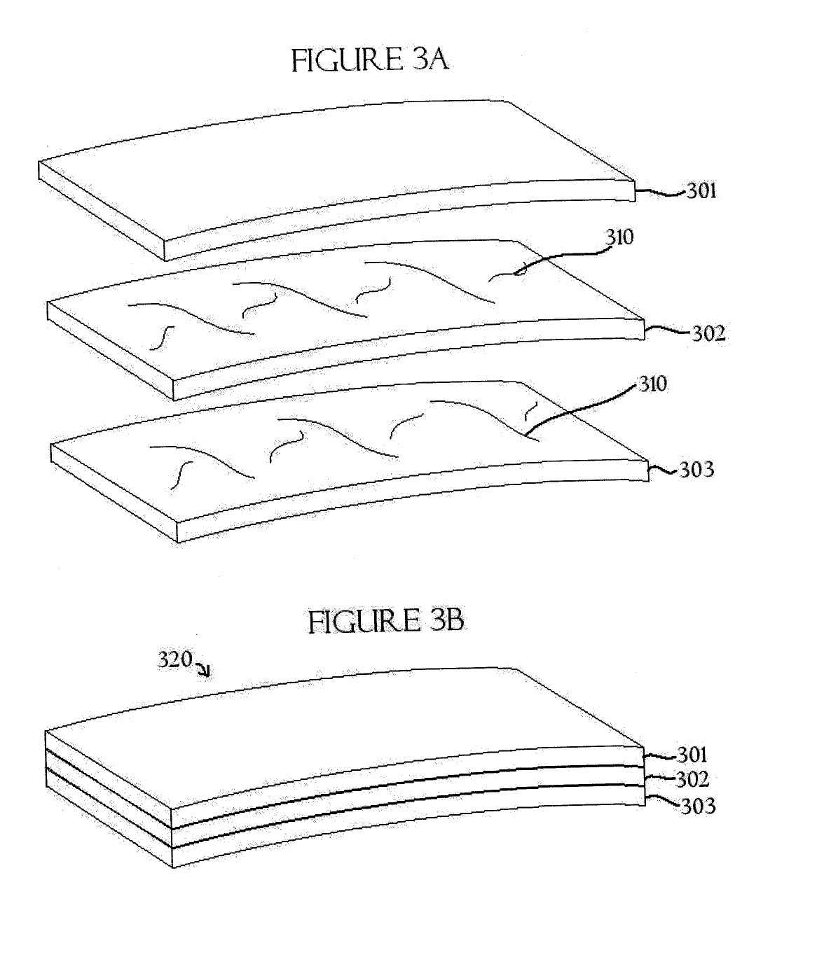

Now referring to FIGS. 3A and 3B, a schematic of a reinforcement stack assembly in accordance with one or more embodiments of the present disclosure is shown. Tape layers 301, 302, and 303 may be combined during a manufacturing process, so that tape layers 301, 302, and 303 may be bonded to form a reinforcement stack 320, as shown in FIG. 3B. Tape layers 301, 302, and 303 may be bonded by an inter-laminar adhesive 310, applied to one or more surfaces of the tape layers. The one or more surfaces that the adhesive may be applied to may be contact surfaces between adjacently stacked and/or collected tape layers. Accordingly, for example, in FIG. 3A, the top surface of tape layer 301 and the bottom surface of tape layer 303 may not have adhesive applied thereto because they are not contact surfaces between tape layers. Therefore, only tape layer 302, in FIG. 3A, may have both the top surface and the bottom surface applied with adhesive 310.

After application of adhesive 310, tape layers 301, 302, and 303 may be collected to form tape stack 320, as shown in FIG. 3B. Tape stack 320 may then be exposed to radiation, as discussed above, so that adhesive 310 may cure and bond tape layers 301, 302, and 303, to form a bonded reinforcement stack. Further, although shown with only three tape layers, those skilled in the art will appreciate that a reinforcement stack, in accordance with one or more embodiments of the present disclosure, may be formed with more or less tape layers without deviating from the scope of the present disclosure.

Now referring to FIGS. 4A-4D, examples of application of the adhesive to the tape layers are shown. In each of FIGS. 4A-4D, tape stack 400 may be collected and formed in collector 401. Collector 401 may allow for tape layers 403 to be compressed into tape stack 400. Adhesive may be applied to one or more surfaces of tape layers 403 by different processes.

For example, referring to FIG. 4A, adhesive 410 may be a film or other tape-like structure that may be provided from a spool or other source, so that a film is placed between each of the adjacent tape layers 403. Alternatively, adhesive 420 may be a sprayed liquid, as shown in FIG. 4B. Or, adhesive 430 may be a powder that may be electrostatically applied, as shown in FIG. 4C. Or, adhesive 440 may be applied by use of a liquid bath or calendars to coat the bonding surfaces of tape layers 403.

Advantageously, bonding reinforcement stacks in accordance with one or more embodiments of the present disclosure may allow for a uniform bonding process. Specifically, radiation may be evenly distributed over a surface of the reinforcement stacks to thereby cure an adhesive that may be located between tape layers that make up the reinforcement stack.

Moreover, processes and/or apparatuses in accordance with one or more embodiments of the present disclosure may allow for a simple manufacturing process. Specifically, a small radiation source may be provided to thereby minimize an assembly line that may be used to assemble wound reinforcement stacks.

Moreover, processes and/or apparatuses in accordance with one or more embodiments of the present disclosure may allow for a faster manufacturing process. Specifically, a quick exposure to radiation to cure adhesive within the reinforcement stacks may eliminate the need to pass a wound reinforcement stack through a large thermal bath.

Moreover, processes and/or apparatuses in accordance with one or more embodiments of the present disclosure may allow for easier application of an adhesive to tape layers to form reinforcement stacks. Specifically, a partially cured adhesive film or a tape layer with an impregnated adhesive resin may be non-sticky, thereby making application of the adhesive or tape layers easier and more efficient.

Moreover, processes and/or apparatuses in accordance with one or more embodiments of the present disclosure may allow execution and/or manufacturing in alternative locations and/or with alternative resources. Because a radiation curing process in accordance with one or more embodiments of the present disclosure is not a convective and/or conduction heating process, adhesive curing may be done at ambient or even low temperature.

Moreover, tape layers and/or adhesives in accordance with one or more embodiments of the present disclosure may not require low temperature storage, may have long open time and long work time, and may not be sticky during manufacturing of the reinforcement stacks

Moreover, processes and/or apparatuses in accordance with one or more embodiments of the present disclosure may allow for fully cured tape layers and/or partially cured tape layers, to be used during manufacturing of reinforcement stacks. Additionally, the adhesive may be uncured and/or partially cured prior to exposure to radiation.

Moreover, processes and/or apparatuses in accordance with one or more embodiments of the present disclosure may allow for thicker and/or different material reinforcement stacks. Particularly, radiation as disclosed herein may have a large depth of penetration, thereby allowing for larger stacks that may be fully cured during the manufacturing process.

Moreover, processes and/or apparatuses in accordance with one or more embodiments of the present disclosure may allow for a fast manufacturing process. Specifically, curing in accordance with one or more embodiments of the present disclosure may occur in a matter of seconds, thereby allowing for manufacturing speeds of up to 10 meters per minute or higher that may depend on tape layer thickness, reinforcement stack height, and/or formed diameter of the wound reinforcement stack or stacks.

Moreover, processes and/or apparatuses in accordance with one or more embodiments of the present disclosure may allow the use of a one-component adhesive and/or resin. This may eliminate the need for mixing and/or may eliminate the possibility of inhomogeneous application and/or curing of the adhesive. Further the limitations of two-component adhesive work time and gel time may also be eliminated. Accordingly, the manufacturing process for high-quality reinforcement stacks may be made more efficient.

Moreover, processes and/or apparatuses in accordance with one or more embodiments of the present disclosure allow for the use of adhesives, resins, and/or composites with desired properties. Specifically, adhesives, resins, and/or composites used pursuant the processes disclosed herein may have, for example, high glass transition temperatures, low void content, and/or good mechanical, physical, thermal, electrical, chemical, environmental, and aging resistances, thereby producing high product performance.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A method to bond fiber reinforced polymer composite tape layers to make reinforcement stacks, the method comprising:
collecting a plurality of composite tape layers to form a reinforcement stack;
helically winding the reinforcement stack; and
curing an adhesive on one or more surfaces of the plurality of composite tape layers by exposing the reinforcement stack to radiation.

2. The method of claim 1, further comprising:
applying adhesive to the one or more surfaces of the plurality of composite tape layers.

3. The method of claim 2, wherein applying adhesive comprises:
forming an adhesive film; and
bonding the adhesive film to the one or more surfaces of the plurality of composite tape layers.

4. The method of claim 2, wherein applying adhesive comprises:
calendaring an adhesive film onto the one or more surfaces of the plurality of composite tape layers.

5. The method of claim 2, wherein applying adhesive comprises:
electrostatically applying an adhesive powder to the one or more surfaces of the plurality of composite tape layers.

6. The method of claim 1, wherein the adhesive comprises at least one of polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, epoxy resin, polyurethane, and polyoxymethylene.

7. The method of claim 1, wherein the adhesive comprises at least one of a liquid, a powder, a gel, a solid, and a film.

8. The method of claim 1, wherein the curing occurs after helically winding the reinforcement stacks.

9. The method of claim 1, wherein one or more of the plurality of composite tape layers comprise pultruded unidirectional fibers.

10. The method of claim 9, wherein the unidirectional fibers comprise at least one of carbon fiber, graphite fiber, E-glass fiber, S-glass fiber, metallic fiber, and chemical-resistant E-glass fiber.

11. The method of claim 1, further comprising:
applying one-component electron beam adhesive formulation liquid to the one or more surfaces of the plurality of composite tape layers,
wherein the radiation comprises electron beam radiation.

12. The method of claim 1, wherein the radiation comprises at least one of UV radiation, electron beam radiation, pulsed infrared beam radiation, and laser radiation.

13.-15. (canceled)

16. The method of claim 1, wherein the adhesive is partially cured prior to the curing by radiation.

17. The method of claim 1, wherein the plurality of composite tape layers are fully cured prior to collecting the plurality of composite tapes to form the reinforcement stacks.

18. The method of claim 1, wherein the plurality of composite tape layers are partially cured prior to collecting the plurality of composite tapes to form the reinforcement stacks.

19. The method of claim 18, wherein the plurality of partially cured composite tape layers are fully cured after exposure to the radiation.

20.-23. (canceled)

24. An apparatus to bond polymer composite reinforcement stacks, the apparatus comprising:
a plurality of tape dispensers configured to dispense a plurality of fiber reinforced polymer composite tape layers;
a collector to form the plurality of composite tape layers into at least one reinforcement stack; and
a radiation source configured to cure an adhesive in the at least one reinforcement stack,
wherein the adhesive is on one or more surfaces of the composite tape layers.

25. (canceled)

26. The apparatus of claim 24, further comprising:
a winding mechanism configured to helically wind the at least one reinforcement stack.

27. The apparatus of claim 26, wherein the radiation source is located downstream in an assembly line from the winding mechanism.

28. The apparatus of claim 24, wherein the radiation comprises at least one of UV radiation, electron beam radiation, pulsed infrared radiation, and laser radiation.

29.-31. (canceled)

32. The apparatus of claim 24, wherein the adhesive comprises at least one of polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, epoxy resin, polyurethane, and polyoxymethylene.

33.-64. (canceled)
